(19) United States
(12) Patent Application Publication
(10) Pub. No.: US 2024/0110013 A1
(43) Pub. Date: Apr. 4, 2024

(54) CURABLE POLYSILOXANES AND PREPARATION OF SAME

(71) Applicant: 3M INNOVATIVE PROPERTIES COMPANY, St. Paul, MN (US)

(72) Inventors: Ken Kawamoto, St. Paul, MN (US); Lindsey R. Kryger, Hudson, WI (US); David S. Hays, Woodbury, MN (US); Christina D. Cowman-Eggert, Inver Grove Heights, MN (US); Daniel Carvajal, Edina, MN (US)

(21) Appl. No.: 18/269,730

(22) PCT Filed: Dec. 23, 2021
(86) PCT No.: PCT/IB2021/062276

§ 371 Date: Jun. 26, 2023

Related U.S. Application Data
(60) Provisional application No. 63/132,679, filed on Dec. 31, 2020.

(51) Int. Cl. C08G 77/20; C08L 83/04

(52) U.S. Cl. CPC C08G 77/20; C08L 83/04

(57) ABSTRACT

A method of preparation of olefin-functionalized fluorosilicones, the properties of which can be optimized, for example, as release liners for silicone adhesives, the method including subjecting a mixture of a hydride-functional polysiloxane, a first compound having a terminal monosubstituted olefin, and a second compound having both a terminal monosubstituted olefin and an internal disubstituted olefin to hydrosilylation conditions to provide a hydrosilylated fluorosilicone with internal olefins and reacting the hydrosilylated fluorosilicone with internal olefins with ethylene in the presence of an olefin metathesis catalyst to provide the olefin- functionalized fluorosilicone. Articles including such olefin-functionalized fluorosilicones.

### TECHNICAL FIELD The present disclosure relates generally to the field of polysiloxanes and particularly to fluorosilicones for use in articles including release liners.

### BACKGROUND

Pressure sensitive adhesives (“PSAs”) are an important class of materials. Generally, PSAs adhere to a substrate with light pressure (e.g., finger pressure) and typically do not require any post-curing (e.g., heat, radiation) to achieve their maximum bond strength. A wide variety of PSA chemistries are available. PSAs, particularly silicone PSAs offer at least one or more of the following useful characteristics: adhesion to low surface energy (“LSE”) surfaces, quick adhesion with short dwell times, wide use temperature (i.e., performance at high and low temperature extremes), moisture resistance, weathering resistance, including but not limited to resistance to ultraviolet (“UV”) radiation, oxidation, and humidity, reduced sensitivity to stress variations (e.g., mode, frequency and angle of applied stresses), and resistance to chemicals (e.g., solvents, plasticizers) and biological substances (e.g., mold, fungi).

### SUMMARY

The present disclosure provides a novel route to preparation of olefin-functionalized fluorosilicones, the properties of which can be optimized, for example, as release liners for silicone adhesives. The property optimization capability is especially important for silicone PSAs because consistent and non-building release has historically been a problem for this class of adhesives, where silicone PSAs perform well in challenging environments like high humidity, high temperatures, and exposure to UV radiation, but their generally good adhesive properties result in issues with release from their own liners.

In one aspect, provided are curable materials including a polysiloxane represented by the formula (I)

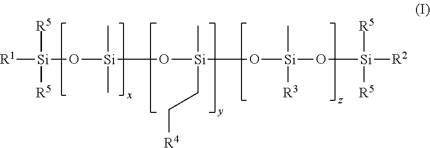

wherein
each R¹ and R² is independently —CH₃ or an alkene represented by the formula

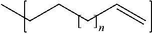

where n is a whole number in the range of 0 to 30 inclusive,
R³ is an alkene represented by the formula

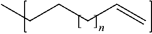

where n is a whole number in the range of 0 to 30 inclusive,
R⁴ is —H, a C1 to C50 alkyl group, a C3 to C50 alkyl ether group, an aryl group, an arylalkylene group, a fluorine-substituted C2 to C20 alkyl group, a fluorine-substituted C2 to C20 alkyl ether group, a C2 to C20 aryl group, or an arylalkylene group,
   x is 0 to 200, optionally 10 to 200,
   y is 0 to 200, optionally 10 to 200, and
   z is 0 to 20, optionally 2 to 20,
      wherein if z is zero, R¹ and R² are both alkenes represented by the formula

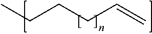

where n is a whole number in the range of 0 to 30 inclusive.

In another aspect, provided are methods of preparing a curable material, the method including subjecting a mixture of a hydride-functional polysiloxane, a first compound having a terminal monosubstituted olefin, and a second compound having both a terminal monosubstituted olefin and an internal disubstituted olefin to hydrosilylation conditions to provide a first product and reacting the first product with ethylene in the presence of an olefin metathesis catalyst to provide the curable material.

In another aspect, provided are hydrosilylated fluorosilicones with internal olefins represented by the formula

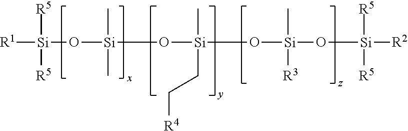

wherein
each R¹ and R² is independently —CH₃ or an alkene represented by the formula

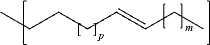

where p is a whole number in the range of 0 to 20 inclusive and m is a whole number in the range of 0 to 10 inclusive,
each R⁵ is independently —Si, alkyl, arylalkylene, aryl, or an alkene represented by the formula

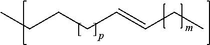

where p is a whole number in the range of 0 to 20 inclusive and m is a whole number in the range of 0 to 10 inclusive,
R⁶ is an alkene represented by the formula

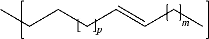

where p is a whole number in the range of 0 to 20 inclusive and m is a whole number in the range of 0 to 10 inclusive,
R⁴ is —H, a C1 to C50 alkyl group, a C3 to C50 alkyl ether group, an aryl group, an arylalkylene group, a fluorine-substituted C2 to C20 alkyl group, a fluorine-substituted C2 to C20 alkyl ether group, a C2 to C20 aryl group, or an arylalkylene group,
   x is 0 to 200, optionally 10 to 200,
   y is 0 to 200, optionally 10 to 200, and
   z is 0 to 20, optionally 2 to 20,

wherein if z is zero, R¹ and R² are both alkenes represented by the formula

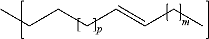

where p is a whole number in the range of 0 to 20 inclusive and m is a whole number in the range of 0 to 10 inclusive,
wherein if z is zero each R⁵ is independently —Si, alkyl, arylalkylene, or aryl.

In another aspect, provided are methods of making a hydrosilylated fluorosilicones with internal olefins, the methods comprising:
subjecting a mixture of a hydride-functional polysiloxane, a first compound having a terminal monosubstituted olefin, and a second compound having both a terminal monosubstituted olefin and an internal disubstituted olefin to hydrosilylation conditions to provide the hydrosilylated fluorosilicone with internal olefins.

In this disclosure, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated.

As used herein:

The term “alkyl” is inclusive of both straight chain and branched chain alkyl groups. Alkyl groups can have up to 50 carbons (in some embodiments, up to 1, 2, 3, 4, 5, 6, 7, 8, 9, or 10 carbons) unless otherwise specified.

The term “cycloalkyl” includes monocyclic or polycyclic groups having from 3 to 10 (in some embodiments, 3 to 6 or 5 to 6) ring carbon atoms.

The term “alkylene” refers to a multivalent (e.g., divalent) form of the “alkyl” groups defined above.

The term “arylalkylene” refers to an alkylene moiety to which an aryl group is attached.

The term “aryl” includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term “pressure sensitive adhesive” (“PSA”) refers to adhesives that possess properties including but not limited to the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power.

Number average molecular weights can be measured, for example, by gel permeation chromatography (i.e., size exclusion chromatography) or by nuclear magnetic resonance spectroscopy using techniques known in the art.

Also herein, recitation of ranges by endpoints includes all numbers subsumed within that range (e.g., 1 to 10 includes 1.4, 1.9, 2.33, 5.75, 9.98).

Features and advantages of the present disclosure will be further understood upon consideration of the detailed description as well as the appended claims

### DETAILED DESCRIPTION

Fluorosilicones are a unique type of polysiloxane, which include fluoroalkyl chains Their low surface energy, low temperature resistance, and high chemical resistance make them especially useful in many applications such as, for example, release liners, specialty elastomers, and repellency applications. For release liner applications, current technologies commonly employ a combination of vinyl- and hydride-functionalized fluorosilicones with a Pt catalyst that catalyzes a hydrosilylation addition cure on- web. Unfortunately, the limited options for fluorosilicones that may be prepared by this process can hinder efforts to develop structure-property relationships and optimize release liner performance. In addition, because these fluorosilicone polymers are synthesized through polycondensation (vide infra), the lot-to-lot variation in terms of number average molecular weight, molecular weight distribution, and vinyl content can be high. Disclosed herein are improved methods for preparing fluorosilicones that allow, inter alia, for optimization of release liner performance and improved control of fluorosilicone polymers material quality.

Vinyl-functionalized fluorosilicones may be prepared through the polycondensation of corrosive dichlorosilane monomers (e.g., dichlorodimethylsilane, a dichloromethylfluoroalkylsilane, and dichloromethylvinylsilane) and the incorporation of an endblocker, such as, for example, 1,1,3,3-tetramethyl-1,3-divinyldisiloxane (Scheme 1). For on-web platinum addition cured release liners, a substrate may be solvent-coated with a mixture of a hydride-functionalized fluorosilicone, olefin-functionalized fluorosilicone, and an inhibited catalyst. When the coating is heated, for example, in an oven, the catalyst is uninhibited and catalyzes a hydrosilylation cure of the hydride and alkene-functionalized fluorosilicones into a polymer network.

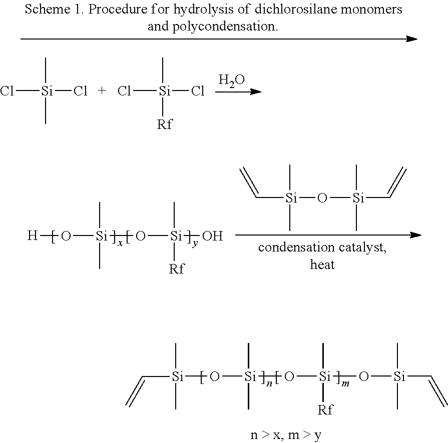

Silicones in general can also be prepared through a method called “equilibration,”0 whereby an endblocker, such as, for example, hexamethyldisiloxane and octamethylcyclotetrasiloxane (D₄) are combined with an acidic or basic catalyst (Scheme 2). Given sufficient time, the siloxane bonds will break and reform until a thermodynamic equilibrium mixture of linear and cyclic species (approximately 85:15, respectively) is reached. The lower order cyclic species like hexamethylcyclotrisiloxane (D₃), octamethylcyclotetrasiloxane (D₄) and decamethylcyclopentasiloxane (D₅), can be removed by vacuum distillation. The number average molecular weight may then be determined by the ratio of endgoups to backbone siloxane units.

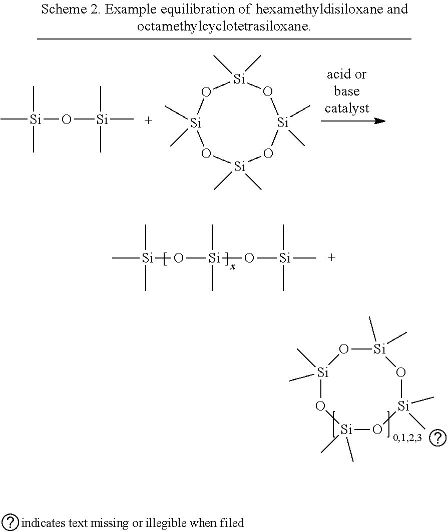

By equilibrating an endblocker and D₄ with tetramethylcyclotetrasiloxane, a silicone fluid with dimethylsiloxane units and methylhydridosiloxane units can be readily prepared, a so-called “hydride fluid.” The lower-order cyclic species that either contain or do not contain methylhydrosiloxane units can also be removed by vacuum distillation (Scheme 3). Equilibration can be a convenient method to produce a linear polysiloxane because the process does not require the use of corrosive chlorosilanes, the product composition and distribution of monomers is reproducible because they are essentially identical if thermodynamic equilibrium is reached, and methods for molecular weight control are well understood.

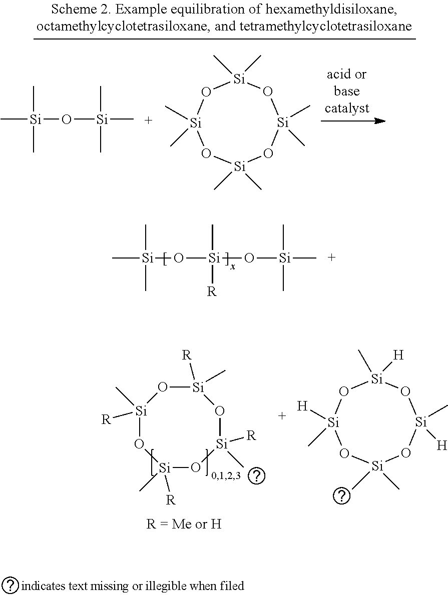

Two possible strategies to prepare an alkene-functionalized fluorosilicone from an equilibrated hydride fluid in one step are shown in Scheme 4. Both of these strategies, however, contain fatal flaws that render their approaches unfeasible.

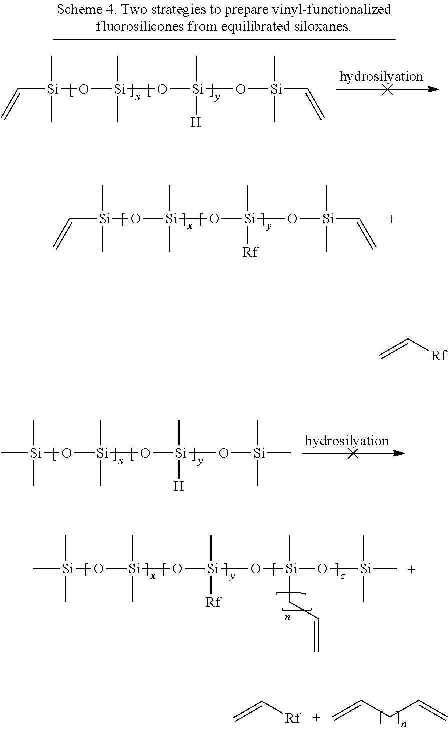

In the top case, the pendant SiH groups would hydrosilylate to the terminal vinyl groups in addition to the fluoroolefin (Scheme 4, top). This would lead to unavoidable gelation. In the bottom case, a potential excess of a diene could be used to bias the reaction toward mono-functionalization rather than crosslinking (Scheme 4, bottom). However, given that far more fluoroalkyl content than olefin content is desired for good release properties, it is not possible to add a large molar excess of diene while simultaneously ensuring that the majority of the SiH groups are consumed by a fluoroolefin.

The present disclosure provides a strategy to prepare vinyl-functionalized fluorosilicones that circumvents at least the problems described above through the hydrosilylation of a diene containing both an internal and terminal olefin (Scheme 5). Conventional hydrosilylation with platinum catalysts is generally unreactive toward internal olefins; this property enables the viability of the present strategy. Then, in a second step, the internal olefin can be converted to a terminal olefin through cross metathesis with ethylene in the presence of an olefin metathesis catalyst (including but not limited to Ru, Mo, W, or Ti-based catalysts). By starting from an equilibrated hydride fluid (commercially available from various sources including the Dow Chemical Company, Shin-Etsu, Momentive Performance Materials, Wacker Chemie AG, or Solvay SA/Rhodia), any process involving chlorosilanes and polycondensation polymerization can be circumvented. Once ethenolyzed, this fluorosilicone with terminal olefins can then be used as the olefin component in a Pt addition-cure with a hydride-functionalized fluorosilicone.

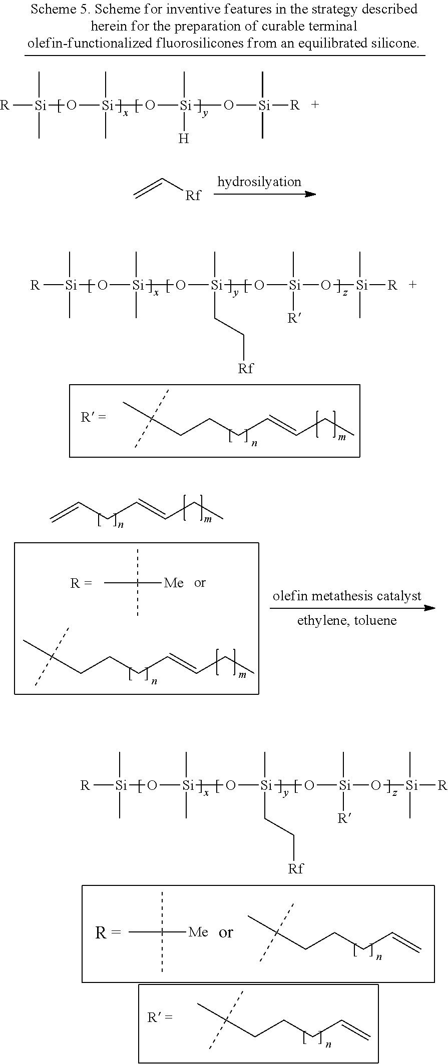

The present disclosure provides a novel route to preparation of olefin-functionalized fluorosilicones, the properties of which can be optimized, for example, as release liners for silicone adhesives, including but not limited to polydiorganosiloxane polyoxamide copolymers, polydiorganosiloxane polyurethane copolymer-based pressure-sensitive adhesives (“PSAs”), and e-beam crosslinked silicone gentle-to-skin PSAs as well as for uses in hydrophobic surface coatings, (e.g., hydrophilic silicone surface coatings). This property optimization is especially important for silicone PSAs because consistent and non-building release has historically been a problem for this class of adhesives, where silicone PSAs perform well in challenging environments like high humidity, high temperatures, and exposure to UV radiation, but their generally good adhesive properties result in issues with release from their own liners.

While the product materials described in this disclosure are primarily fluorosilicones, it is expected that one or more functional groups and/or polymers may be grafted to a silicone backbone in this novel manner including, for example, alkyl groups, polyolefins, polyethers, antimicrobial compounds, acrylic moieties, and combinations thereof.

In one aspect provided are curable materials comprising:
a polysiloxane represented by the formula

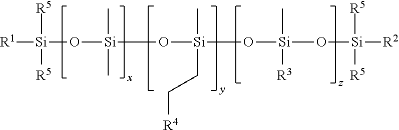

wherein
each R¹ and R² is independently —CH₃ or an alkene represented by the formula

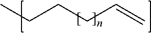

where n is a whole number in the range of 0 to 30 inclusive,
R³ is an alkene represented by the formula

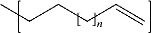

where n is a whole number in the range of 0 to 30 inclusive,
R⁴ is —H, a C1 to C50 alkyl group, a C3 to C50 alkyl ether group, an aryl group, an arylalkylene group, a fluorine-substituted C2 to C20 alkyl group, a fluorine-substituted C2 to C20 alkyl ether group, a C2 to C20 aryl group, or an arylalkylene group,
   x is 0 to 200, optionally 10 to 200,
   y is 0 to 200, optionally 10 to 200, and
   z is 0 to 20, optionally 2 to 20,
      wherein if z is zero, R¹ and R² are both alkenes represented by the formula

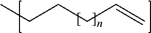

where n is a whole number in the range of 0 to 30 inclusive. In some preferred embodiments, the polysiloxane has a number average molecular weight of 2000 g/mol to 150000 g/mol, optionally 2000 g/mol to 100000 g/mol, optionally 5000 g/mol to 20000 g/mol, or optionally 50000 g/mol to 150000 g/mol. In some preferred embodiments, the polysiloxane has a number average molecular weight of 50000 g/mol to 150000 g/mol. In some embodiments a release liner may include the curable material described above.

In another aspect, provided are methods of making a curable material, the method comprising:
subjecting a mixture of a hydride-functional polysiloxane, a first compound having a terminal monosubstituted olefin, and a second compound having both a terminal monosubstituted olefin and an internal disubstituted olefin to hydrosilylation conditions to provide a first product; and
reacting the first product with ethylene in the presence of an olefin metathesis catalyst to provide the curable material. In some preferred embodiments the olefin metathesis catalyst is selected from the group consisting of a ruthenium catalyst, a tungsten catalyst, a molybdenum catalyst, a rhenium catalyst, a titanium catalyst, and combinations thereof. In some preferred embodiments, the curable material comprises a terminal olefin-functionalized polysiloxane. In some embodiments, the terminal olefin-functionalized polysiloxane comprises a functionalized fluorosilicone having a number average molecular weight of 2000 g/mol to 1000000 g/mol, optionally 5000 g/mol to 40000 g/mol. In some embodiments, the curable material comprises:
a polysiloxane represented by the formula

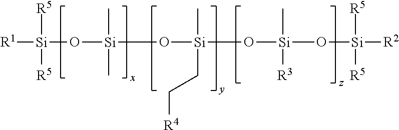

wherein
each R¹ and R² is independently —CH₃ or an alkene represented by the formula

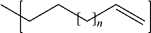

where n is a whole number in the range of 0 to 30 inclusive,
R³ is an alkene represented by the formula

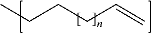

where n is a whole number in the range of 0 to 30 inclusive,
R⁴ is —H, a C1 to C50 alkyl group, a C3 to C50 alkyl ether group, an aryl group, an arylalkylene group, a fluorine-substituted C2 to C20 alkyl group, a fluorine-substituted C2 to C20 alkyl ether group, a C2 to C20 aryl group, or an arylalkylene group,
   x is 0 to 200, optionally 10 to 200,
   y is 0 to 200, optionally 10 to 200, and
   z is 0 to 20, optionally 2 to 20,
   wherein if z is zero, R¹ and R² are both alkenes represented by the formula

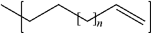

where n is a whole number in the range of 0 to 30 inclusive.

Articles including the curable material may be prepared by methods known in the art. In some embodiments, the articles comprise a release liner.

Objects and advantages of this disclosure are further illustrated by the following non-limiting examples, but the particular materials and amounts thereof recited in these examples, as well as other conditions and details, should not be construed to unduly limit this disclosure.

### EXAMPLES Unless otherwise noted or readily apparent from the context, all parts, percentages, ratios, etc. in the Examples and the rest of the specification are by weight.

TABLE 1
Materials and Abbreviations Used in the Examples

| Abbreviation/Name | Description/Source |
|---|---|
| 7048 | Poly(methylhydridosiloxane), obtained under the trade designation |
| | “SYL-OFF 7048” from The Dow Chemical Company, Midland, |
| | MI |
| HMDS | Hexamethyldisiloxane, obtained from Alfa Aesar, Tewksbury, |
| | MA |
| Darco-G60 | Activated carbon, 100-325 mesh, obtained under the trade |
| | designation “DARCO G-60” from EMD Millipore, Burlington, |
| | MA |
| D4 | Octamethylcyclotetrasiloxane, obtained under the trade |
| | designation “XIAMETER PMX-0244” from The Dow Chemical |
| | Company, Midland, MI |
| Sulfuric Acid | Obtained from Millipore Sigma, Burlington, MA |
| 10-undecenal | Obtained from Millipore Sigma, Burlington, MA |
| 2,2,3,3,4,4,4-heptafluorobutanol | Obtained from 3M Company, St. Paul, MN |
| Allyl bromide | Obtained from Alfa Aesar, Tewksbury, MA |
| KOH | Potassium hydroxide, obtained from Alfa Aesar, Tewksbury, MA |
| Ethyltriphenylphosphonium | Obtained from TCI America, Portland, OR |
| bromide | |
| KOtBu | Potassium tert-butoxide, obtained from Alfa Aesar, Tewksbury, |
| | MA |
| Silica gel | Silica gel 60, 230-450 mesh for chromatography, obtained from |
| | Alfa Aesar, Tewksbury, MA |
| Karstedt's catalyst (used for | Platinum(0)-1,3-divinyl-1,1,3,3-tetramethyldisiloxane complex |
| synthesis) | concentrate, obtained from Heraeus Group, Hanau, Germany |
| 1-octene | Obtained from Alfa Aesar, Tewksbury, MA |
| 1-propynol | Obtained from Alfa Aesar, Tewksbury, MA |
| Celite 545 | Diatomaceous earth, obtained under the trade designation |
| | “CELITE 545” from Millipore Sigma, Burlington, MA |
| Ethylene | Obtained from Airgas, Radnor, PA |
| Argon | Obtained from Oxygen Service Company, St. Paul, MN |
| Grubbs' 1^{st} generation catalyst | Benzylidene-bis(tricyclohexylphosphine)dichlororuthenium, |
| | obtained under the trade designation “GRUBBS CATALYST, 1^{st} |
| | GENERATION” from Millipore Sigma, Burlington, MA |
| Anhydrous toluene | Toluene obtained from Millipore Sigma, Burlington, MA, sparged |
| | with argon, passed through a column of activated Brockmann type |
| | I alumina, also from Millipore Sigma, Burlington, MA, stored in |
| | nitrogen-filled glovebox |
| Micropore S Tape | Tape obtained under the trade designation “3M MICROPORE S |
| | Silicone Surgical Tape” from 3M Company, St. Paul, MN |
| 8403 Tape | Tape obtained under trade designation “3M Polyester Tape 8403 |
| | Silicone Adhesive Tape” from 3M Company, St. Paul, MN |
| HFE7300 | 1,1,1,2,2,3,4,5,5,5-decafluoro-3-methoxy-4- |
| | (trifluoromethyl)-pentane, obtained under the trade designation, |
| | “3M NOVEC Engineered Fluid” from 3M Company, St. Paul, |
| | MN |
| Karstedt's (used for coatings) | Platinum(0)-1,3-divinyl-1,1,3,3-tetramethyldisiloxane complex in |
| | xylene, obtained from Gelest, Morrisville, PA |
| Diallyl maleate | Inhibitor, obtained from Momentive Performance Materials, |
| | Waterford, NY |
| 7785 | Vinyl-functionalized fluorosilicone coating, obtained under the |
| | trade designation SYL-OFF Q2-7785″ from The Dow Chemical |
| | Company, Midland, MI |
| 7560 | Hydride-functionalized fluorosilicone crosslinker, obtained under |
| | the trade designation SYL-OFF Q2-7560″ from The Dow |
| | Chemical Company, Midland, MI |
| M | Me₃SiO_{1/2}, trimethylsiloxane unit |
| D | Me₂SiO_{2/2}, dimethylsiloxane unit |
| D′ or D^{H} | MeHSiO_{2/2}, methylhydridosiloxane unit |
| T | MeSiO_{3/2} |
| Q | SiO_{4/2} |

### Preparatory Examples

Preparation of hydride fluid—PE1

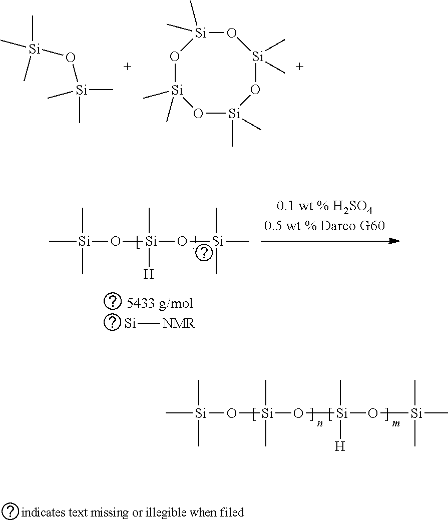

To a 64 oz polypropylene bottle was added 419.49 g (0.08 mol, 1.00 equiv., Mₙ 5433 g/mol by ²⁹ Si-NMR) of SYL-OFF 7048, 999.25 g (3.37 mol, 43.61 equiv.) of D4, 24.13 g (0.15 mol, 1.91 equiv.) of HMDS, 7.44 g (0.5 wt %) of DARCO-G60, and 1.48 g (0.1 wt %) of sulfuric acid. The bottle was placed on a shaker for three days. Then, the reaction was filtered through a 0.6 μm filter (Meissner Filtration Products, Camarillo, CA). The low molecular weight cyclics were stripped from the flask under vacuum while heating. The vacuum pressure was between 0.4 and 1 torr while the temperature was increased from 50 to 120 ° C. After no more condensate could be collected at 120° C., the flask was cooled while sparging with nitrogen. A silicone with a hydride equivalent weight of 214.9 g/mol of SiH, Mₙ of 5759 g/mol by ²⁹ Si-NMR, 53.9 D units and 26.8 D′ units was isolated.

Preparation of 4-allyloxy-1,1,1,2,2,3,3-heptafluorobutane—PE2

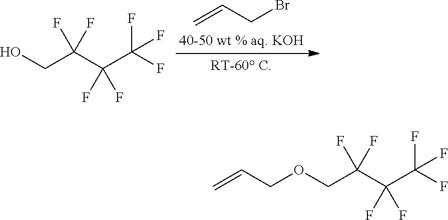

To a 12 L round bottom resin kettle with a 4-port head equipped with a mechanical stirrer, thermocouple, bubble-type condenser, and N₂ inlet was added 2602.62 g of 40 wt % KOH aqueous 20 solution. The mixture was stirred at 200 rpm. 2860.09 g of 2,2,3,3,4,4,4-heptafluorobutanol was added via addition funnel over the course of 2 hours. Once the addition was complete, 1829.28 g of allyl bromide was added dropwise while monitoring the exotherm over the course of 45 minutes, eventually reaching 78.8° C. The mixture was allowed to stir overnight and cool. The next day, an additional 344.16 g of 40 wt % KOH solution was added and then heated to 40° C. for two days. The reaction had reached 83.1% conversion by ¹⁹F-NMR analysis. The reaction mixture was allowed to cool and the desired product was isolated by fractional distillation.

Preparation of 1,11-tridecadiene—PE3

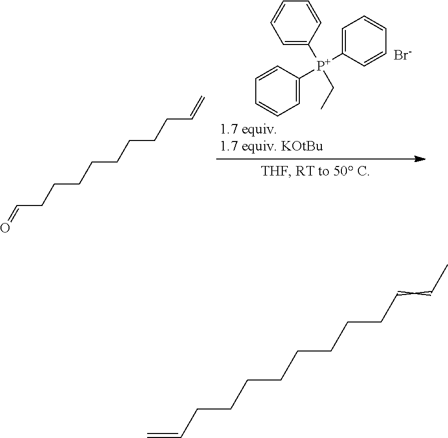

To a 2.5 L glass reactor, 170.79 g of KOtBu and 566.54 g of ethyltriphenylphosphonium bromide were added. The reactor was stirred slowly while purging with nitrogen for 20 minutes. During stirring, the Wittig reagent began to form, as evidenced by the formation of orange color where the white powders were being mixed. Then, approximately 2 L of THF, stored over 4A molecular sieves (Omnisolv, MilliporeSigma, Burlington, MA) for two days, was added. The mixture instantly turned orange and turned more and more bright orange. The mixture exothermed to approximately 36.8 ° C. and eventually cooled. After 25 minutes, 10-undecenal (154.4 g, neat) was added via an addition funnel over the course of approximately one hour. The internal temperature reached a maximum of 50 ° C.

After 3 hours from initial addition, an aliquot was removed, diluted in hexane, and quenched with water. ¹H-NMR of the aliquot showed the complete disappearance of the aldehyde peak, and approximately 90.5% conversion. The addition funnel was removed and replaced with a short path distillation head. A heating mantle was added under the reactor and heated until the solvent began to reflux. The THF was removed until the mixture became an orange slurry. Once the majority of the THF was removed, 800 mL of heptane was added and that mixture was distilled out until the contents became a thick orange slurry.

Then, 800 mL of deionized water was added to the reaction. A further 500 mL of heptane was added. The reactor was stirred vigorously at 400 rpm until the white solids were resuspended. The layers were allowed to separate, and the top layer was aspirated out. The aqueous layer was extracted three more times with 400 mL of heptane and a total of approximately 1.6 L of organic fractions were isolated. Then, the murky mixture was filtered through a large Whatman paper filter (type 54, hardened low ash). The heptane mixture was then concentrated on a rotary evaporator.

The mixture was then filtered through a small pad of silica in a glass column with hexane washes. The mixture was concentrated on a rotary evaporator. 135 g of a clear, colorless liquid was isolated. The desired product was isolated by fractional vacuum distillation at 150 mTorr. The product was collected at 70-74° C. and 106.2 g of a clear, colorless liquid was isolated in 69% yield.

### Preparation of PE4

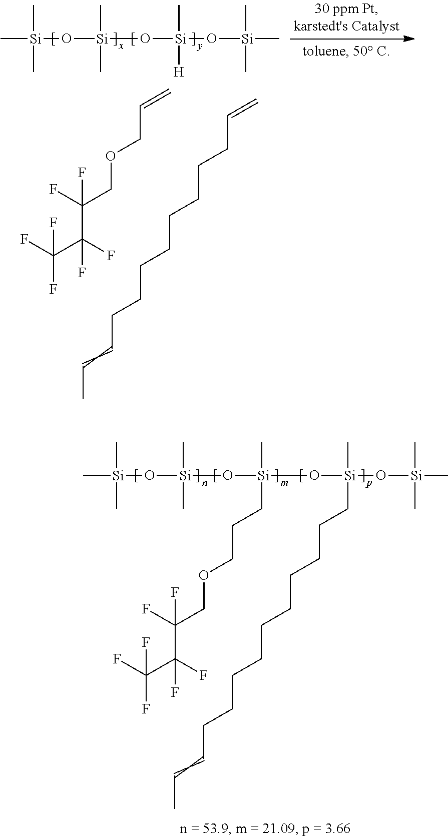

To a three neck 500 mL round bottom flask equipped with a thermocouple, reflux condenser, and a short path distillation head was added 30.47 g of hydride fluid PE1. 83 g of toluene was added and then 23.3 g was distilled out to azeotrope out residual water. The flask was allowed to cool to 50 ° C. under the flow of nitrogen. Then, 49.98 g of 4-allyloxy-1,1,1,2,2,3,3-heptafluorobutane (stored over 4 Å molecular sieves, PE2) was added after filtering through a 0.45 um PTFE syringe filter. 5.6599 g of 1,11-tridecadiene PE3 was then added to the flask. The flask was stirred at 50 ° C.

Then, 26 uL of an 18.218 wt % Pt in divinyltetramethyldisiloxane (Karstedt's concentrate from Heraeus Group, Hanau, Germany) was added neat. The reaction slowly exothermed from 51.4° C. to 88.4° C., after which the reaction began to cool down to 50 ° C. After 2.5 hours, an aliquot for ¹-NMR showed the total disappearance of the SiH group. 8.07 g of 1-octene and 1 uL of Karstedt's concentrate was added to the reaction to ensure complete consumption of the SiH. The mixture was concentrated on a rotary evaporator and then stripped under vacuum at 4.4 mTorr and 110° C. until no condensate was collected. The brown mixture was then dissolved in hexane, stirred with 1-propynol and passed through a 6″ pad of CELITE 545. The flask was then concentrated on a rotary evaporator and sparged with nitrogen to remove any remaining volatiles to yield 54.98 g of a clear, yellow oil. The product appeared to have 53.9 D units, 3.66 D units with an internal olefin, and 21.09 D units with the fluorinated moiety by a combination of ¹³C-NMR and ²⁹Si-NMR. Approximately 0.04 D′ units, 1.33 T units, and 0.48 Q units were also observed.

### Preparation of PE5

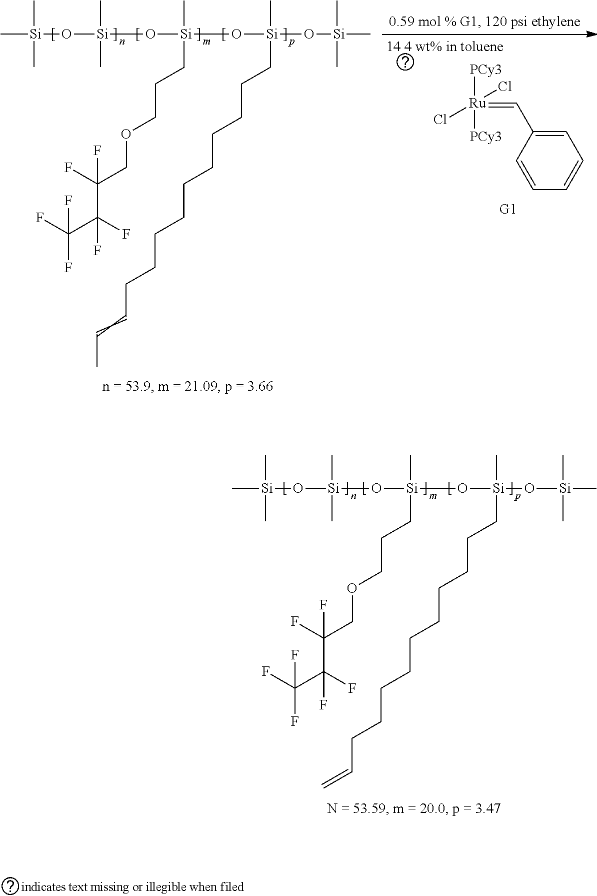

To a 2L Parr vessel (from Parr Instrument Company, Moline, IL) was added 46.81 g of PE4. Then 279 g of toluene was poured on top and the Parr was closed. The solution was stirred at 150 rpm and sparged with argon at 5 psi and between 100-300 mL/min flow rate. Then, after ran hour and a half, the gas was switched to ethylene at 20 psi/50-100 mL/min flow rate.

In a nitrogen-filled glovebox, a 74.2 mg of Grubbs' 1st generation catalyst was weighed out and dissolved in 20 mL of anhydrous toluene. The solution was transferred to a Schlenk vessel, sealed, and removed from the box. Then, the pressure of the Parr vessel was dropped to 1 psi. The entire catalyst solution was taken up in a glass gas-tight syringe and then injected into the Parr against 1 psi of pressure. The vessel was then increased to 120 psi of ethylene and allowed to slowly sparge at a flow rate of around 10-50 mL/min. The reaction was allowed to stir at room temperature overnight.

The ethylene was allowed to vent and outgas from the reactor open to the air. Then, after one hour, the contents of the reactor were poured into a round bottom flask and concentrated to a brown oil using rotatory evaporation. The brown mixture was diluted with 100 g of hexane and poured into a column packed with silica gel, FLORISIL (Millipore Sigma, and silica gel (three layers). The majority of the brown/black Ru appeared to stay on the top of the column, and 29 g of a brown oil was collected. A combination of ¹³C-NMR and ²⁹Si-NMR analysis determined that the product had 53.59 D units, 20 D units with fluorinated groups, and 3.47 terminal olefins (90% conversion of original internal olefins). The olefin equivalent molecular weight was 3130 g/mol.

### Examples

### Coating Formulations and Method (Table 2):

Formulated release solutions were made at 22 weight percent solids in heptane, 20:80 heptane/ethyl acetate, and 80:20 heptane/methylethylketone, or 10 weight percent solids in HFE7300, using SYL-OFF Q2-7560 as the crosslinker in all formulations. The olefin-functionalized fluorosilicone was varied between commercial SYL-OFF Q2-7785 or PE5 and the stoichiometry between the crosslinker and olefin-functionalized fluorosilicone was varied. A solution of Karstedt's catalyst for coatings, including diallyl maleate as the inhibitor, was prepared to target 150 ppm Pt and 0.2 wt % inhibitor in each formulated release solution in the solvent of choice. These solutions were then coated on to HOSTAPHAN 3 SAB polyester backing (primed polyester available from Mitsubishi Polyester Film, Inc., Wiesbaden, Germany) using a #5 Mayer rod (wire wound rod available from RD Specialties, Inc., Webster, NY) and thermally cured in an oven at 120° C. for 30 seconds.

### 180° Peel Adhesion and Readhesion Method

Prepared release liners were aged for a minimum of one week at 23 ° C. and 50 percent relative humidity before any tests were conducted. Unless otherwise noted, release test samples were prepared by laminating (using a 15 cm wide soft rubber roller and light pressure) the release liners to various cured, silicone adhesives. The resulting samples were aged at 50° C. for predetermined amounts of time such as 14 days or 28 days. All samples were then re-equilibrated at 23° C. and 50 percent relative humidity for at least one day prior to testing. After aging and re-equilibration, a 2.54 or 1.6 centimeter wide and approximately 20 centimeter long sample of the test sample was cut using a specimen razor cutter. The cut sample was applied lengthwise onto the platen surface of a peel adhesion tester (an IMASS SP-2 100 tester, obtained from IMASS, Inc., Accord, MA) using 3M Double Coated Paper Tape 410M (available from 3M Company, St. Paul, MN). The release liner was peeled from the adhesive at an angle of 180 degrees at 30.5 cm/minute.

Readhesion samples were prepared by applying the adhesive strip exposed by the release test to either a clean stainless steel plate or a clean glass plate using two back and forth passes (four passes total) with a 4.4 cm wide two kilogram rubber roller. Readhesions for 8403 tape was performed against a glass substrate while readhesions for Micropore S were performed against a stainless steel substrate. Readhesion was measured without dwell time by measuring the force required to peel the adhesive from the plate at an angle of 180 degrees at 30.5 cm/minute.

TABLE 2
Formulations and Extractables of Release Coatings

| | | | | | | Extract- |
|---|---|---|---|---|---|---|
| Exam- | Hy- | | Ratio Hy- | Wt % Solids | | ables |
| ple | dride | Vinyl | dride:Vinyl | in Solvent | Solvent | (wt %) |
| EX1 | 7560 | PE5 | 1:1 | 22% | 20:80 | 8.0 |
| | | | | | Hep:EA | |
| EX2 | 7560 | PE5 | 1:1 | 22% | 80:20 | 9.1 |
| | | | | | Hep:MEK | |
| EX3 | 7560 | PE5 | 1:1 | 22% | Heptane | 13.3 |
| EX4 | 7560 | PE5 | 2:1 | 10% | HFE7300 | 8.5 |
| EX5 | 7560 | PE5 | 2:1 | 22% | 20:80 | 10.2 |
| | | | | | Hep:EA | |
| EX6 | 7560 | PE5 | 2:1 | 22% | 80:20 | 5.2 |
| | | | | | Hep:MEK | |
| EX7 | 7560 | PE5 | 2:1 | 22% | Heptane | 12.2 |
| EX8 | 7560 | PE5 | 3:1 | 22% | 20:80 | 3.0 |
| | | | | | Hep:EA | |
| EX9 | 7560 | PE5 | 3:1 | 22% | 80:20 | 7.0 |
| | | | | | Hep:MEK | |
| EX10 | 7560 | PE5 | 3:1 | 22% | Heptane | 7.4 |
| CE1 | 7560 | 7785 | 2:1 | 22% | 20:80 | 3.9 |
| | | | | | Hep:EA | |
| CE2 | 7560 | 7785 | 2:1 | 22% | Heptane | 4.7 |

TABLE 3
Liner Release Adhesion and Readhesion data for 8403
Tape with 14 day Aging at 50° C. at 12 inches/minute

| | Adhesion 180° | 95% | Readhesion 180° Peel | 95% |
|---|---|---|---|---|
| Example | Peel Force (g/in) | Conf | Force (oz/in) | Conf |
| Control (8403 | 631.29 | 57.83 | 14.33 | 0.87 |
| from self) | | | | |
| EX1 | 311.74 | 32.96 | 12.38 | 0.40 |
| EX2 | 375.84 | 83.89 | 11.80 | 1.32 |
| EX3 | 342.68 | 20.26 | 9.62 | 0.69 |
| EX4 | 796.88 | 23.59 | 12.28 | 0.41 |
| EX5 | 418.66 | 37.11 | 9.83 | 0.69 |
| EX6 | 393.63 | 10.39 | 9.97 | 0.29 |
| EX7 | 503.96 | 35.63 | 9.87 | 0.38 |
| EX8 | 580.92 | 12.61 | 7.37 | 0.08 |
| EX9 | 569.86 | 9.63 | 10.07 | 0.19 |
| EX10 | 562.68 | 21.34 | 7.96 | 0.65 |
| CE1 | 11.25 | 5.49 | 10.54 | 0.34 |
| CE2 | 22.66 | 0.99 | 10.12 | 0.57 |

TABLE 4
Liner Release Adhesion and Readhesion data for Micropore
S Tape with 14 day Aging at 50° C. at 12 inches/minute

| | Adhesion 180° | 95% | Readhesion 180° Peel | 95% |
|---|---|---|---|---|
| Example | Peel Force (g/in) | Conf | Force (oz/in) | Conf |
| Control | 490.17 | 2.89 | 7.64 | 1.14 |
| (Micropore S | | | | |
| from self) | | | | |
| EX1 | 358.74 | 16.62 | 7.54 | 0.47 |
| EX2 | 370.62 | 16.85 | 7.48 | 0.29 |
| EX3 | 351.09 | 20.90 | 7.54 | 0.68 |
| EX4 | 401.97 | 11.70 | 7.19 | 0.39 |
| EX5 | 388.95 | 21.13 | 6.99 | 0.47 |
| EX6 | 366.00 | 24.57 | 6.35 | 0.55 |
| EX7 | 359.54 | 47.49 | 5.83 | 1.70 |
| EX8 | 410.52 | 45.22 | 5.86 | 1.59 |
| EX9 | 408.78 | 32.47 | 7.02 | 0.41 |
| EX10 | 424.46 | 22.06 | 7.14 | 0.35 |
| CE1 | 234.02 | 20.24 | 6.98 | 0.49 |
| CE2 | 248.85 | 20.07 | 6.23 | 0.66 |

1. A curable material comprising:
a polysiloxane represented by the formula 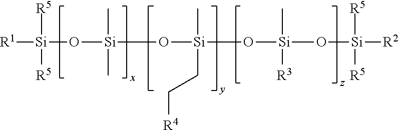
wherein
each R¹ and R² is independently —CH₃ or an alkene represented by the formula 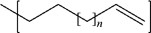
where n is a whole number in the range of 0 to 30 inclusive,
each R⁵ is independently —Si, alkyl, arylalkylene, aryl, or an alkene represented by the formula 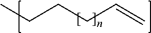
where n is a whole number in the range of 0 to 30 inclusive,
R³ is an alkene represented by the formula 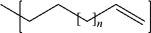
where n is a whole number in the range of 0 to 30 inclusive,
R⁴ is —H, a C₁ to C₅₀ alkyl group, a C₃ to C₅₀ alkyl ether group, an aryl group, an arylalkylene group, a fluorine-substituted C₂ to C₂₀ alkyl group, a fluorine-substituted C₂ to C₂₀ alkyl ether group, a C₂ to C₂₀ aryl group, or an arylalkylene group,
x is 0 to 200, optionally 10 to 200,
y is 0 to 200, optionally 10 to 200,
z is 0 to 20, optionally 2 to 20, and
wherein if z is zero, R¹ and R² are both alkenes represented by the formula 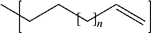
where n is a whole number in the range of 0 to 30 inclusive, and wherein if z is zero each R⁵ is independently —Si, alkyl, arylalkylene, or aryl.

2. The curable material of claim 1, wherein the polysiloxane has a number average molecular weight of 2000 g/mol to 150000 g/mol, optionally 2000 g/mol to 100000 g/mol, optionally 5000 g/mol to 20000 g/mol, or optionally 50000 g/mol to 150000 g/mol.

3. The curable material of claim 1, wherein the polysiloxane has a number average molecular weight of 50000 g/mol to 150000 g/mol.

4. A release liner comprising the curable material of claim 1.

5. A method of making a curable material, the method comprising:
subjecting a mixture of a hydride-functional polysiloxane, a first compound having a terminal monosubstituted olefin, and a second compound having both a terminal monosubstituted olefin and an internal disubstituted olefin to hydrosilylation conditions to provide a first product; and
reacting the first product with ethylene in the presence of an olefin metathesis catalyst to provide the curable material.

6. The method of claim 5, wherein the olefin metathesis catalyst is selected from the group consisting of a ruthenium catalyst, a tungsten catalyst, a molybdenum catalyst, a rhenium catalyst, a titanium catalyst, and combinations thereof.

7. The method of claim 5, wherein the curable material comprises a terminal olefin-functionalized polysiloxane.

8. The method of claim 7, wherein the terminal olefin-functionalized polysiloxane comprises a functionalized fluorosilicone having a number average molecular weight of 2000 g/mol to 1000000 g/mol, optionally 2000 g/mol to 100000 g/mol, optionally 5000 g/mol to 40000 g/mol.

9. The method of claim 5, wherein the curable material comprises:
a polysiloxane represented by the formula 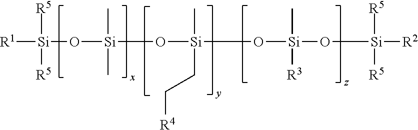
wherein
each R¹ and R² is independently —CH₃ or an alkene represented by the formula 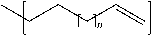
where n is a whole number in the range of 0 to 30 inclusive,
each R⁵ is independently —Si, alkyl, arylalkylene, aryl, or an alkene represented by the formula 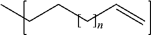
where n is a whole number in the range of 0 to 30 inclusive,
R³ is an alkene represented by the formula 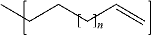
where n is a whole number in the range of 0 to 30 inclusive,
R⁴ is —H, a C₁ to C₅₀ alkyl group, a C₃ to C₅₀ alkyl ether group, an aryl group, an arylalkylene group, a fluorine-substituted C₂ to C₂₀ alkyl group, a fluorine-substituted C₂ to C₂₀ alkyl ether group, a C₂ to C₂₀ aryl group, or an arylalkylene group,
x is 0 to 200, optionally 10 to 200,
y is 0 to 200, optionally 10 to 200,
z is 0 to 20, optionally 2 to 20, and
wherein if z is zero, R¹ and R² are both alkenes represented by the formula 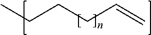
where n is a whole number in the range of 0 to 30 inclusive, and
wherein if z is zero each R⁵ is independently —Si, alkyl, arylalkylene, or aryl.

10. An article including the curable material prepared according to the method of claim 5.

11. An article including the curable material prepared according to the method of claim 5, wherein the article is a release liner.

12. A hydrosilylated fluorosilicone with internal olefins represented by the formula 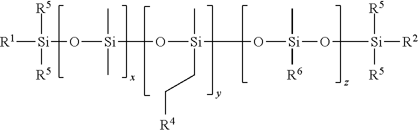
wherein
each R² and R² is independently —CH₃ or an alkene represented by the formula 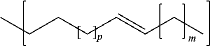
where p is a whole number in the range of 0 to 20 inclusive and m is a whole number in the range of 0 to 10 inclusive,
each R⁵ is independently —Si, alkyl, arylalkylene, aryl, or an alkene represented by the formula 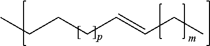
where p is a whole number in the range of 0 to 20 inclusive and m is a whole number in the range of 0 to 10 inclusive,
R⁶ is an alkene represented by the formula 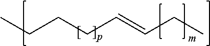
where p is a whole number in the range of 0 to 20 inclusive and m is a whole number in the range of 0 to 10 inclusive,
R⁴ is —H, a C1 to C50 alkyl group, a C3 to C50 alkyl ether group, an aryl group, an arylalkylene group, a fluorine-substituted C2 to C20 alkyl group, a fluorine-substituted C2 to C20 alkyl ether group, a C2 to C20 aryl group, or an arylalkylene group,
x is 0 to 200, optionally 10 to 200,
y is 0 to 200, optionally 10 to 200, and
z is 0 to 20, optionally 2 to 20,
wherein if z is zero, R¹ and R² are both alkenes represented by the formula 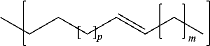
where p is a whole number in the range of 0 to 20 inclusive and m is a whole number in the range of 0 to 10 inclusive,
wherein if z is zero each R⁵ is independently —Si, alkyl, arylalkylene, or aryl.

13. The hydrosilylated fluorosilicone with internal olefins of claim 12, wherein the polysiloxane has a number average molecular weight of 2000 g/mol to 150000 g/mol, optionally 2000 g/mol to 100000 g/mol, optionally 5000 g/mol to 20000 g/mol, or optionally 50000 g/mol to 150000 g/mol.

14. The hydrosilylated fluorosilicone with internal olefins of claim 12, wherein the polysiloxane has a number average molecular weight of 50000 g/mol to 150000 g/mol.

15. A method making a hydrosilylated fluorosilicone with internal olefins, the method comprising:
subjecting a mixture of a hydride-functional polysiloxane, a first compound having a terminal monosubstituted olefin, and a second compound having both a terminal monosubstituted olefin and an internal disubstituted olefin to hydrosilylation conditions to provide the hydrosilylated fluorosilicone with internal olefins.

16. The method of claim 15, wherein the hydrosilylated fluorosilicone with internal olefins is represented by the formula 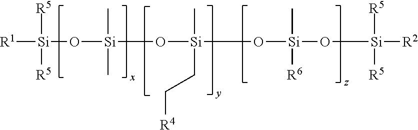
wherein
each ¹ and R² is independently —CH₃ or an alkene represented by the formula 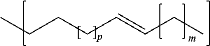
where p is a whole number in the range of 0 to 20 inclusive and m is a whole number in the range of 0 to 10 inclusive,
each R⁵ is independently —Si, alkyl, arylalkylene, aryl, or an alkene represented by the formula 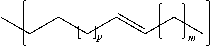
where p is a whole number in the range of 0 to 20 inclusive and m is a whole number in the range of 0 to 10 inclusive,
R⁶ is an alkene represented by the formula 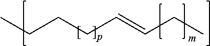
where p is a whole number in the range of 0 to 20 inclusive and m is a whole number in the range of 0 to 10 inclusive,
R⁴ is —H, a C1 to C50 alkyl group, a C3 to C50 alkyl ether group, an aryl group, an arylalkylene group, a fluorine-substituted C2 to C20 alkyl group, a fluorine-substituted C2 to C20 alkyl ether group, a C2 to C20 aryl group, or an arylalkylene group,
x is 0 to 200, optionally 10 to 200,
y is 0 to 200, optionally 10 to 200, and
z is 0 to 20, optionally 2 to 20,
wherein if z is zero, R¹ and R² are both alkenes represented by the formula 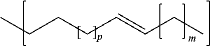
where p is a whole number in the range of 0 to 20 inclusive and m is a whole number in the range of 0 to 10 inclusive,
wherein if z is zero each R⁵ is independently —Si, alkyl, arylalkylene, or aryl.

17. The method of claim 15, wherein the polysiloxane has a number average molecular weight of 2000 g/mol to 150000 g/mol, optionally 2000 g/mol to 100000 g/mol, optionally 5000 g/mol to 20000 g/mol, or optionally 50000 g/mol to 150000 g/mol.

18. The method of claim 15, wherein the polysiloxane has a number average molecular weight of 50000 g/mol to 150000 g/mol.
